(19) United States
(12) Patent Application Publication
(10) Pub. No.: US 2025/0217012 A1
(43) Pub. Date: Jul. 3, 2025

(54) LOGICALLY GROUPING ELEMENTS USING TAGS FOR VISUALIZATION IN A VIRTUAL SIMULATION

(71) Applicant: Cisco Technology, Inc., San Jose, CA (US)

(72) Inventors: Justin G. Guagliata, Saint Louis, MO (US); Ralph Schmieder, Karlsruhe (DE); Joseph Michael Clarke, Cary, NC (US)

(21) Appl. No.: 18/400,966

(22) Filed: Dec. 29, 2023

(51) Int. Cl. G06F 3/0484; G06F 40/169

(52) U.S. Cl. CPC G06F 3/0484; G06F 40/169

(57) ABSTRACT

A method performed by a computer device with a display comprises: generating a graphical user interface (GUI) that presents a layout of nodes on a display canvas; tagging each node in a subset of the nodes with a tag that identifies a common node property that the subset of the nodes share in common, to produce tagged nodes; and responsive to tagging, visually grouping the tagged nodes into a visible annotation on the display canvas, wherein the visible annotation is configured as a polygon that has vertices formed by the tagged nodes and sides extending between the vertices to form a perimeter around the tagged nodes, and that encloses an area filled with a fill characteristic to indicate the common node property.

### TECHNICAL FIELD

The present disclosure relates to visualizing nodes of a topology based on tags applied to the nodes.

### BACKGROUND

Existing network simulation tools provide an annotation feature that allows a user to draw an annotation on a display canvas to group nodes that represent network elements. The visible annotation is not linked or otherwise associated to the nodes, and is typically created manually. Therefore, the visible annotation is static and does not easily accommodate topological changes of the nodes.

### BRIEF DESCRIPTION OF THE DRAWINGS

FIG. 1 is a diagram of a network simulation environment that includes a network simulator through which a user creates, modifies, and visualizes a virtual network using node tagging techniques, according to an example embodiment.

FIG. 2 is an illustration of a node configuration for a node of the virtual network, according to an example embodiment.

FIG. 3 is an illustration of tag configuration information stored after a user has created nodes of the virtual network, and after tags have been created and assigned to the nodes for purposes of visualizing node properties of the nodes, according to an example embodiment.

FIG. 4 shows a graphical user interface (GUI) generated for display by the network simulator and through which a user manually creates and visualizes a node of the virtual network, according to an example embodiment.

FIG. 5 shows a GUI through which the user manually assigns to the node a tag associated with a node property, according to an example embodiment.

FIG. 6 shows a GUI that presents (i.e., visualizes) multiple groups of nodes using distinct visible annotations responsive to/triggered by repeatedly performing creating and tagging operations described in connection with FIGS. 4 and 5, according to an example embodiment.

FIG. 7 shows a GUI that presents a visible annotation in an initial configuration triggered responsive to creating and tagging each node in a group or subset of nodes with a common tag, according to an example embodiment.

FIG. 8 shows a reformed version of the visible annotation of FIG. 7 that results when one of the nodes in the visible annotation is moved away from the initial configuration, according to an example embodiment.

FIG. 9 shows fragmentation of the visible annotation of FIG. 8 when the one of the nodes has moved beyond a threshold distance, according to an example embodiment.

FIG. 10 shows a GUI that presents a visible annotation of commonly tagged nodes and that includes an exclusion zone for a node that is not one of the commonly tagged nodes, according to an example embodiment

FIG. 11 shows a GUI that presents user selectable ON-OFF tag controls, according to an example embodiment.

FIG. 12 is a flowchart of operations used to perform dynamic/automated tagging of nodes, according to an example embodiment.

FIG. 13 is a flowchart of an example method of dynamically and selectively visualizing nodes of a network based on tagging the nodes with tags that identify node/network properties, according to an example embodiment.

FIG. 14 illustrates a hardware block diagram of a computing device that may perform functions associated with operations performed in the embodiments presented herein, according to an example embodiment.

### DETAILED DESCRIPTION

### Overview

In an embodiment, a method performed by a computer device with a display comprises: generating a graphical user interface (GUI) that presents a layout of nodes on a display canvas; tagging each node in a subset of the nodes with a tag that identifies a common node property that the subset of the nodes share in common, to produce tagged nodes; and responsive to tagging, visually grouping the tagged nodes into a visible annotation on the display canvas, wherein the visible annotation is configured as a polygon that has vertices formed by the tagged nodes and sides extending between the vertices to form a perimeter around the tagged nodes, and that encloses an area filled with a fill characteristic to indicate the common node property.

In another embodiment, a computer-implemented method comprises: storing configurations that define node properties of nodes; displaying the nodes on a display canvas presented by a graphical user interface (GUI); discovering the node properties and which of the node properties are allocated to which of the nodes; creating tags that define respective ones of the node properties found by discovering; tagging the nodes with the tags to match how the node properties are allocated to the nodes, to produce tagged nodes; and responsive to tagging, visually grouping the tagged nodes into visible annotations based on the tags such that each visible annotation encompasses commonly tagged nodes of the tagged nodes that share a common tag that define a common node property.

### Example Embodiments

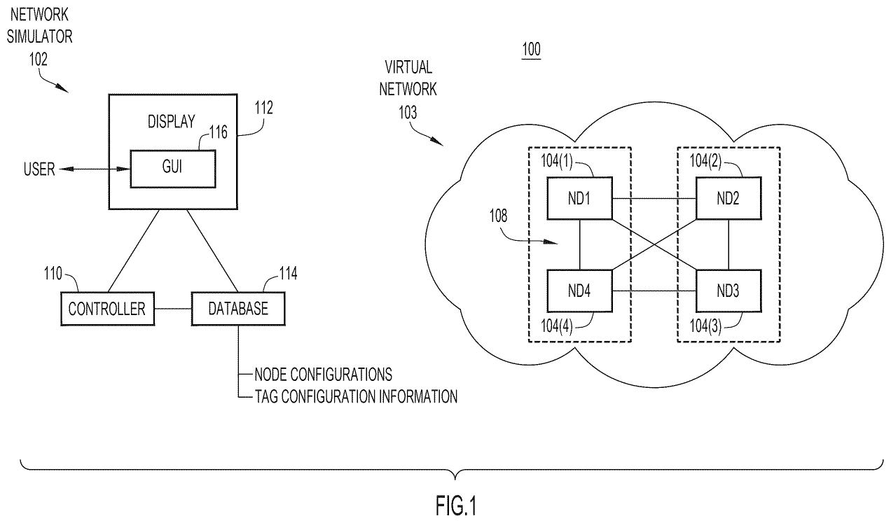

FIG. 1 is a diagram of an example network simulation environment 100 that includes a network simulator 102 through which a user creates, modifies, and visualizes virtual components of a virtual network 103 (also referred to as a virtualized network) using node tagging techniques according to embodiments presented herein. The user may employ network simulator 102 to simulate an actual network. Network simulator 102 includes a controller 110, a display 112, and a database 114. Controller 110 generates for display various interactive graphical user interface (GUIs), represented generally by GUI 116, and presents the GUI on display 112. The user interacts with GUI 116 to create, modify, and visualize components of virtual network 103. Database 114 stores underlying network configuration information for virtual network 103 used to perform simulations and also stores tag configuration information defining tags associated with network properties and that are used to control network visualization, as described below. Using GUI 116, the user may construct the aforementioned network configuration information and tag configuration information stored in database 114, and may control (e.g., execute) a network simulation performed on virtual network 103.

In the example of FIG. 1, virtual network 103 includes nodes 104(1)-104(4) (also referred to as nodes ND1-ND4, and collectively referred to as nodes 104) that represent network nodes, such as routers and switches. Virtual network 103 includes links 108 that connect the nodes, and which represent network links that connect the network nodes to one another. Four nodes are shown by way of example, only. Other examples may include more or less than four nodes. Based on the underlying node configurations in database 114, nodes 104 (also referred to as virtual network nodes) may be configured to implement/simulate various network operations, including network protocols, to communicate with each other, and to route network traffic (e.g., data packets) across virtual network 103 over links 108. Such network protocols include, but are not limited to the Internet Protocol (IP) suite of protocols, Ethernet protocols, routing protocols, discovery protocols, or any other known or hereafter developed protocols.

Controller 110 employs network simulation utilities to control and monitor virtual network 103 and network simulations performed on the virtual network. For example, controller 110 may scan/search the node configurations in database 114 for various node properties, execute network simulations, detect operations performed by the nodes during the network simulations, discover protocols that the nodes are capable of using and detect when the nodes actually use (i.e., execute or invoke) the protocols during network simulations, implement traffic sniffers and filters to monitor/filter traffic to and from the nodes, assign tags to the nodes (as described below), and use the traffic filters to discover node operations and properties that match the tags, and so on.

Using GUI 116, the user assigns or applies to nodes 104 tags that identify node properties or features of (i.e., allocated to) the nodes. The tags may be employed for purposes of filtering and searching the node properties of the nodes that are tagged, as included in their node configurations. The embodiments presented herein extend the use of the tags beyond filtering and searching. According to the embodiments, the tags trigger automatic visual grouping of the nodes that are tagged by drawing visible annotations (e.g., areas shaded with a distinct visible fill characteristic) around the nodes on a display canvas (i.e., a visual display area) of GUI 116. A distinct visible annotation is drawn around all nodes that have/share the same tag (i.e. that share a common tag). Multiple tags may be assigned to each node. Nodes to which multiple tags are assigned may be included in multiple visible annotations, simultaneously. This provides distinct visual groupings of the nodes that share the common tags (like overlapping Venn diagrams around the nodes). The tags and the corresponding visible annotations can be enabled (i.e., turned ON) and disabled (i.e., turned OFF) on a per tag basis.

A visible annotation is dynamically drawn around the commonly tagged nodes based on their current positions, such that the visible annotation automatically follows the nodes (i.e., reforms the size and shape of the visible annotation) as the user drags/moves one or more of the commonly tagged nodes around the display canvas. When a tagged node is moved beyond a threshold distance, the visible annotation fragments into multiple visible annotations that separately encompass the tagged nodes that did not move and the tagged node that moved. When the visible annotation encompasses a node that is not commonly tagged, a visible exclusion zone is formed around that node. These and other features will become apparent from the description below.

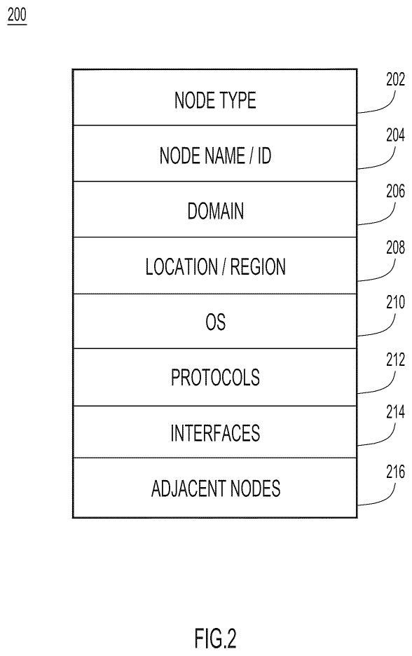

FIG. 2 is an illustration of an example node configuration 200 stored in database 114 for a node of virtual network 103. Database 114 may store many such node configurations for corresponding nodes to support virtualized/simulated node operations. The node configurations may be supplied by the user through GUI 116, imported from a file, or discovered from an actually deployed network, for example. Node configuration 200 includes a node type 202 (e.g., router, switch, controller), a node name or identifier (ID) 204, a node domain 206 (e.g., *.com), a node location or region 208, an identifier of an operating system (OS) 210 used by the node, a list of network protocols 212 employed by the node and logic to implement/simulate the protocols, node interface information 214, and a list of adjacent nodes 216 connected to the node. More or less node properties may be included in any given node configuration.

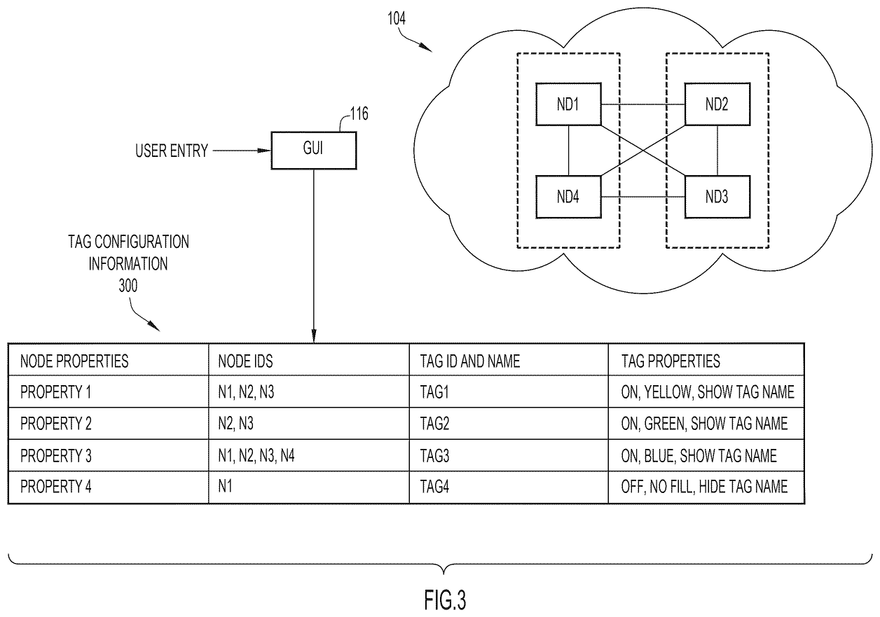

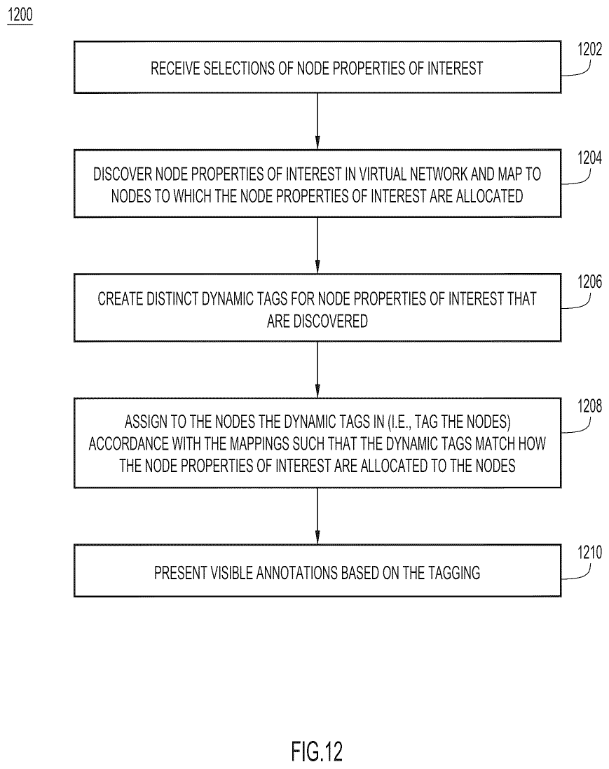

FIG. 3 is an illustration of tag configuration information 300 stored in database 114 after the user has created nodes 104, and after tags have been created and assigned to the nodes for purposes of visualizing node properties of the nodes. Assigning the tags to the nodes is also referred to as “tagging” the nodes with the tags to produce tagged nodes. In a manual tagging embodiment, the user creates the tags and assigns the tags to the nodes (i.e., tags the nodes) using GUI 116. In a dynamic tagging embodiment, initially, the user may enter into GUI 116 a list of node properties of interest. Then, without further user intervention, network simulator 102 (e.g., controller 110) automatically discovers (e.g., scans/searches) virtual network 103 (including the node configurations) to find nodes that have the node properties of interest, (ii) creates tags that identify the node properties of interest that are found by the discovery, and (iii) automatically assigns the tags to the nodes as “dynamic tags.” The dynamic tagging embodiment is described below in connection with FIG. 12.

Tag configuration information 300 links or associates the tags to corresponding ones of the nodes to which the tags are assigned and to corresponding visible annotations. Tag configuration information 300 includes entries of rows corresponding to tags TAG1, TAG2, TAG3, and TAG4 that have been assigned to the nodes. Each row includes fields or columns that include various information associated with each tag. In the example, moving left-to-right, the columns include node properties, node IDs, tag ID, and tag properties for each tag. The node property identifies a node property or feature of a node (or nodes) that is indicated/identified by, and thereby associated with, a tag. The node properties may include a network/routing protocol (e.g., transaction control protocol (TCP)/IP (IP/TCP), open shortest path first (OSPF) protocol, border gateway protocol (BGP), enhanced interior gateway routing protocol (EIGRP), and so on), a node name, a node domain, a node location/region, and the like. The node IDs list the one or more nodes that have been tagged by the tag. The tag ID/name is the identifier of the tag. The tag properties include user definable/configurable features of the tag and the visible annotation associated with the tag.

The user definable features of the tag configure characteristics of the visible annotation associated with the tag, including a fill characteristic for the visible annotation, an ON-OFF tag control (e.g., toggle) associated with the visible annotation, and a tag-name show control. The fill characteristic may specify for the visible annotation one or more of a color (e.g., blue, yellow, red, and so on), a shading (e.g., dark or light), a fill pattern (e.g., a type of cross-hatching), no fill, and so on. The ON-OFF tag control has a first value or state that turns ON the tag and a second value that turns OFF the tag. When the ON-OFF tag control is set to ON to turn ON the tag, GUI 116 presents the visible annotation associated with the tag (i.e., the visible annotation is also turned ON). When the ON-OFF tag control is set to OFF to turn OFF the tag, GUI 116 suppresses the visible annotation associated with the tag (i.e., the visible annotation is also turned OFF); however, the tag remains linked to the nodes to which the tag is assigned. The tag-name show control, when set to ON, causes the name of the tag to be presented with the visible annotation. The tag-name show control, when set to OFF, causes the name of the tag to be hidden (i.e. not shown). Other tag properties are possible.

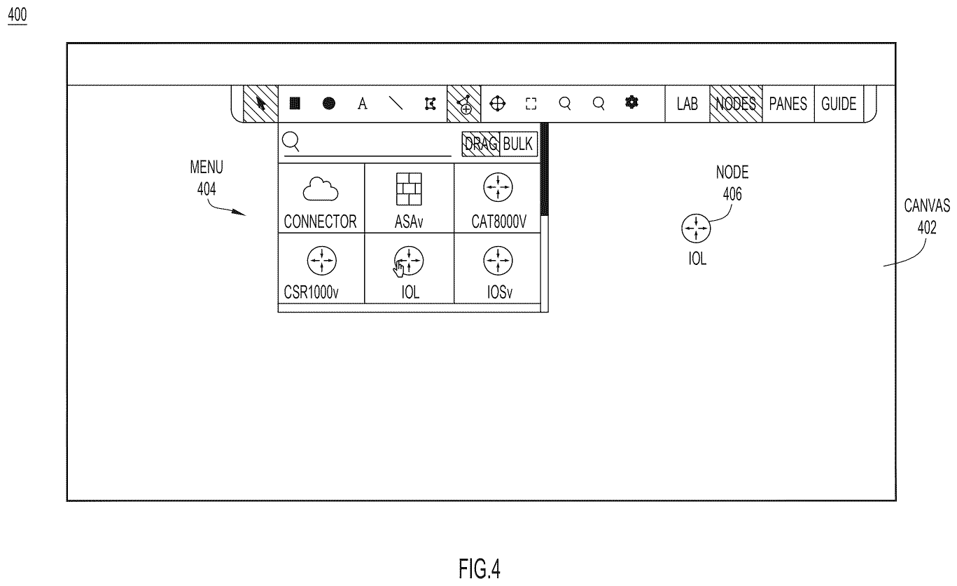

FIG. 4 is an illustration of an example GUI 400 generated for display by network simulator 102 and presented on display 112, and through which a user manually creates and visualizes a node. GUI 400 includes a two-dimensional (2D) display canvas 402 for presenting a topology of nodes in a 2D area and a drop-down menu 404. Drop-down menu 404 presents a matrix of user selectable pre-named “node create” icons. To create a node, the user selects a node add icon for a desired node (e.g., IOL), and drags the node add icon to a node position on the display canvas. Responsive to the aforementioned actions, network simulator 102 instantiates/creates a node 406 (e.g., node IOL-0) at the node position. Nodes are enumerated in increasing order (e.g., −0, −1, 2, . . . ) as they are added. The node name (e.g., IOL) may be pre-assigned to the corresponding node create icon, or may be entered by the user when the node is created. In addition, the node create icons may be linked to corresponding predetermined node configurations. In this way, when the user creates a node, network simulator 102 may automatically link the node to the corresponding node configuration, which may be used for simulating network operations on the node, and for automatic tagging of the node, as described below. In another example, all tags and their associated nodes may be instantiated and modified using an application programming interface (API).

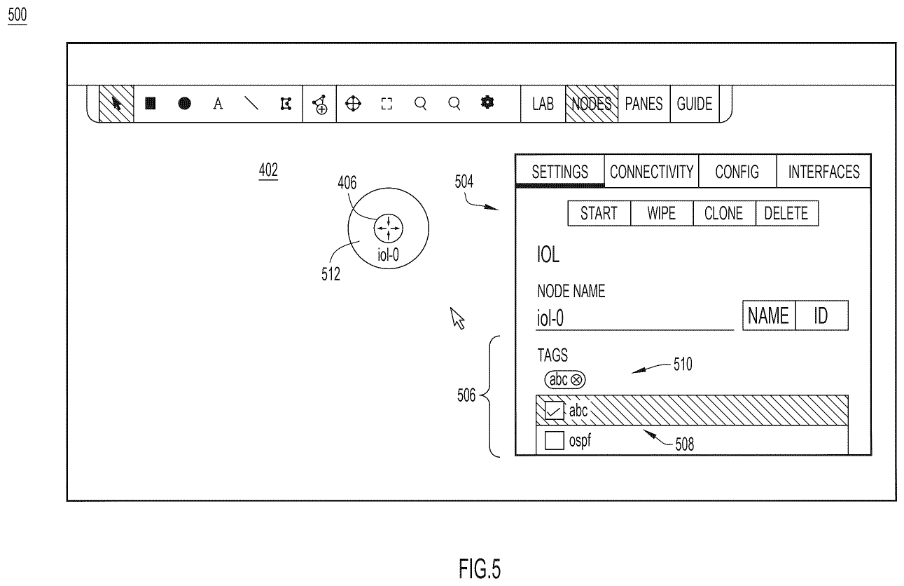

FIG. 5 is an illustration of an example GUI 500 through which the user manually assigns a tag associated with a node property to the node created in connection with FIG. 4. GUI 500 additionally includes a side panel 504 that appears when node 406 is created and selected. Side panel 504 that lists the name of node 406 (e.g., IOL), and also includes tag add fields 506. In the example, tag add fields 506 present to the user selectable existing tags 508 (e.g., ABC and OSPF), that when selected (i.e., when selections of the existing tags are received), become assigned to node 406. Alternatively, the user may enter a new tag at 510. To tag node 406, the user selects one or more of existing tags 508 (e.g., checks the box next to tag name ABC) and/or enters a new tag name at 510. Responsive to the aforementioned actions, network simulator 102 assigns one or more tags to node 406.

As described above in connection with FIG. 3, each tag includes user configurable tag properties associated with the tag that define/control the visible annotation associated with the tag, such as whether the visible annotation is turned ON or OFF, a fill characteristic for the visible annotation, and whether the tag name (also referred to as a tag descriptor) is to be presented. Such tag properties may be supplied to tag configuration information 300 by default initially when the tag is created, and/or the user may configure the tag properties through interaction with one or more GUI features. For example, the tag is instantiated with a default color and other default properties/settings which may be updated by the user. The tag is created upon the assignment of that tag to a node for the first time and removed upon the removal of that tag from the last node that has the tag. In the example of FIG. 3, node IOL-0 is assigned a tag named ABC (i.e., “tag ABC”), and the tag is turned ON. The tag name may identify the node property represented by the tag. The tag triggers the presentation of visible annotation 512 on display canvas 402. The user actions described in connection with GUIs 400 and 500 may be repeated to construct a complex topology of nodes that are tagged to trigger visible annotations of the nodes in accordance with the tags.

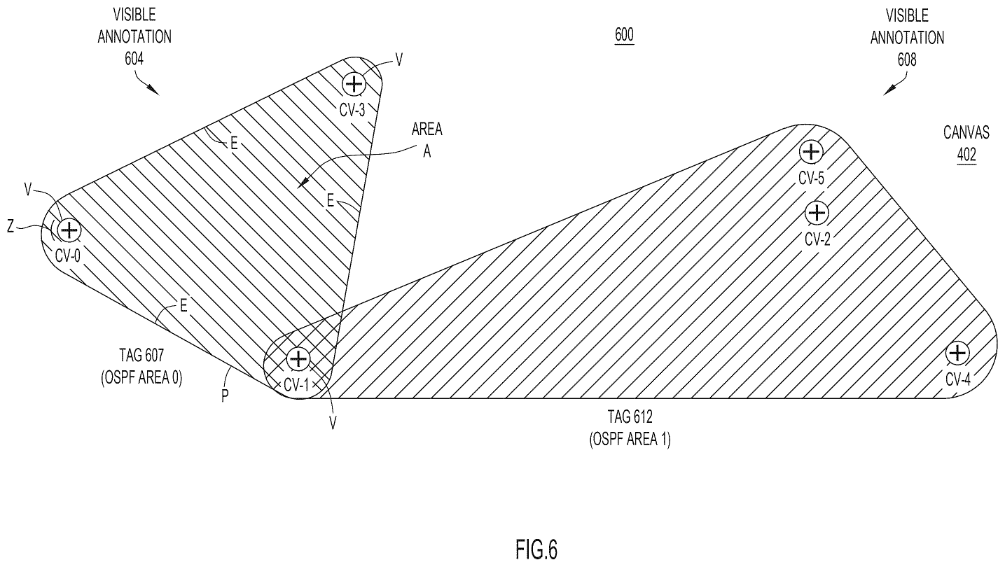

FIG. 6 is an illustration of an example GUI 600 that presents (i.e., visualizes) multiple groups of nodes using distinct visible annotations responsive to/triggered by repeating the creating and tagging operations described above in connection with FIGS. 4 and 5. Specifically, display canvas 402 presents (i) a visible annotation 604 encompassing a group of nodes Cv-0, -1, and -3 (where “c” represents a device name CAT8000, for example) each tagged with a tag 607 (e.g., which is associated with a node property=OSPF Area 0), and (ii) a visible annotation 608 for a group of nodes Cv-1, -2, -4, and -5 each tagged with a tag 612 (e.g., which is associated with a node property OSPF Area 1). The tag properties for tags 607, 612 are configured to (i) turn ON the tags (and thus turn ON the visible annotations), (ii) define different/distinct fill characteristics for visible annotations 604, 608, and (iii) show tag names (e.g., tag 607=OSPF Area 0 and tag 612=OSPF Area 1). The node Cv-1 is tagged with both tags and therefore falls into visible annotations 604 and 608 simultaneously. Another tag property includes layer height, which may be used when multiple visible annotations overlap. In that case, the tag (i.e., the visible annotation drawn for the tag) with the greatest height is drawn on top.

As shown in FIG. 6, GUI 600 presents each visible annotation as a polygon having vertices V formed by the (commonly) tagged nodes associated with the visible annotation. The polygon includes straight edges or sides E that extend between the vertices to form a perimeter P that stretches tightly around the tagged nodes. The polygon may be regular, irregular, may be rectangular, and may not be rectangular, depending on/to reflect the topology of the nodes. The perimeter encloses an area A filled with a distinct fill characteristic that indicates the common tag (i.e., the common node property). In an example, the perimeter P is drawn tightly around the tagged nodes to minimize area A and/or the perimeter. For example, the polygon may be configured as a smallest perimeter polygon that encompasses all of the vertices/nodes. Any known or hereafter developed technique may be used to determine perimeter P around a 2D topology formed by vertices V so as to minimize perimeter P and/or area A enclosed by the perimeter, for example to form the polygon as a convex hull. The perimeter P stretches around the tagged nodes so as to provide a limited-area clearance ring or zone Z around each tagged node, such that the sides meet or terminate at the clearance zones and do not touch the tagged node, which reduces clutter.

The visible annotation may be dynamically reformed responsive to movement of one or more of the nodes of the annotation. For example, the user may select a node encompassed by the visible annotation, and drag the node across the display canvas. While the node is being moved (i.e., responsive to the movement), network simulator 102 dynamically detects and tracks the movement (i.e., the change in position of the node) and automatically reforms (e.g., resizes and reshapes) the visible annotation in real-time such that the node remains encompassed by the visible annotation while the node is being moved. To do this, network simulator 102 adjusts lengths of adjoining sides (e.g., stretches or shrinks the lengths) of the polygon that are incident to the node and also adjusts the area. Adjusting/reforming the perimeter in real-time responsive to movement of the nodes, so that the perimeter is always stretched around the nodes, gives the perimeter an clastic appearance, as if the perimeter were formed as a rubber-band stretched around moving pegs on a board.

In addition, while the node is being moved, network simulator 102 detects when the position of the node moves a threshold distance away from the perimeter of the visible annotation (or from some other reference position encompassed by the visible annotation) as initially configured. In an example, the threshold distance may be configured as a property of the tag associated with the visible annotation. When the position of the moving node crosses or exceeds the threshold distance, network simulator 102 breaks the visible annotation into a first annotation that encompasses the nodes that did not move and a second annotation that encompasses the node that has moved. Breaking the visible annotation into separated visible annotations avoids stretching the visible annotation across display canvas 402 and helps reduce clutter.

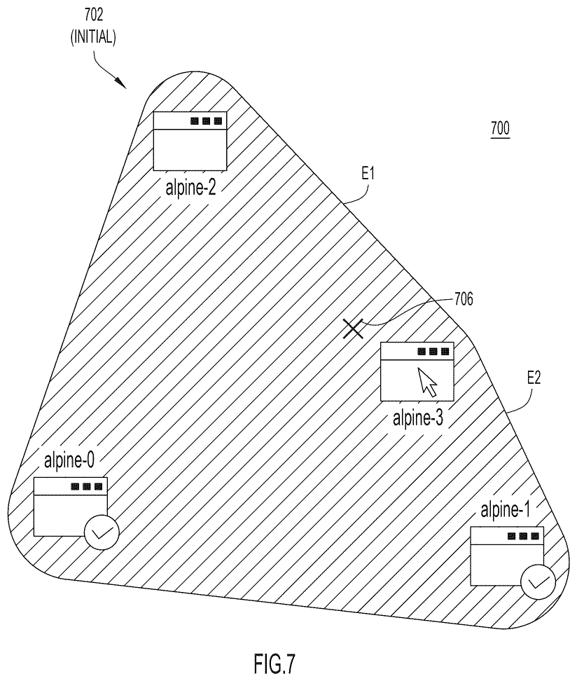

An example of the dynamic nature of the visible annotation responsive to user action is provided in connection with FIGS. 7-9.

FIG. 7 shows an example GUI 700 that presents a visible annotation 702 that has an initial configuration or shape triggered responsive to creating and tagging nodes ALPINE-0-ALPINE-3 with a common tag. Visible annotation 702 includes initial perimeter with sides E1, E2 incident to node ALPINE-3 in an initial position 706.

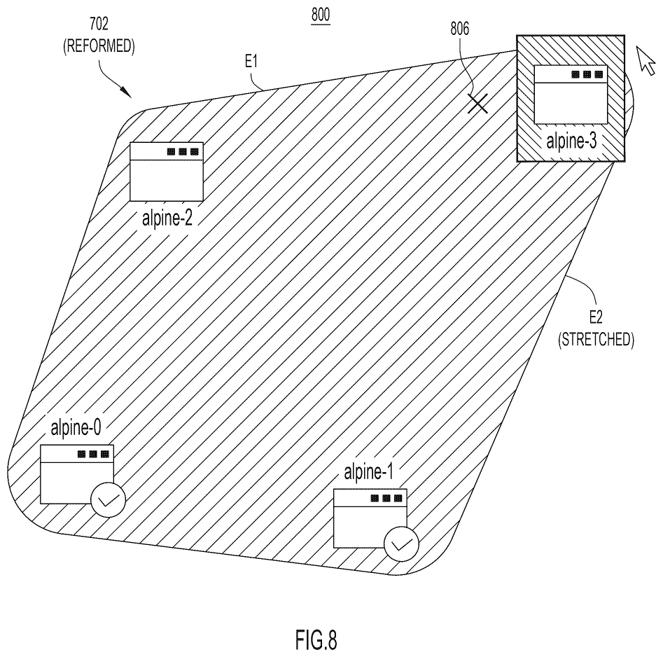

FIG. 8 shows an example GUI 800 that presents visible annotation 702 in a reformed (e.g., resized and reshaped) configuration responsive to movement of node ALPINE-3 away from (e.g., to the right of) initial position 706, to a new position 806. The source of the node movement may be either that of the user by directly interacting with the GUI or via an API call. Network simulator 102 reforms the configuration of visible annotation 702 responsive to the movement to ensure that node ALPINE-3 remains encompassed by the visible annotation. That is, the presentation of visible annotation 702 is updated in real time as node ALPINE-3 is moved. Specifically, network simulator 102 dynamically stretches sides E1, E2 and the area of visible annotation 702 in real-time as the node is moved to accommodate the movement. The real-time stretching of sides E1, E2 to follow node ALPINE-3 as the node moves gives visible annotation 702 an elastic appearance. Conversely, if node ALPINE-3 were being moved inward into the area of visible annotation 702 instead of away from the area, sides E1, E2 may be dynamically shrunk in real-time to reduce the area. At new position 806, node ALPINE-3 has not yet moved beyond the threshold distance that would trigger separation of visible annotation 702 into separated visible annotations. Therefore, visible annotation 702 remains whole.

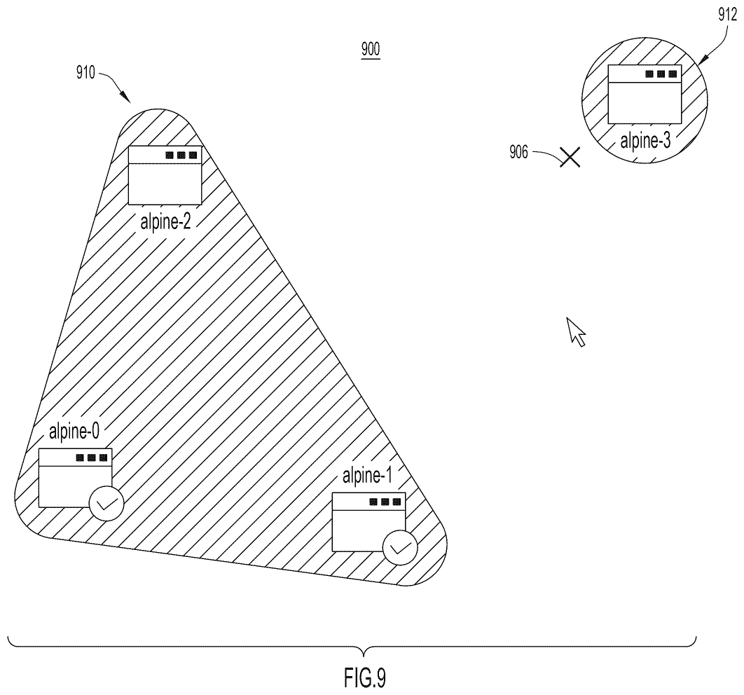

FIG. 9 shows an example GUI 900 after/when node ALPINE-3 moves to a position 906 that is beyond the threshold distance that triggers separation or fragmentation of visible annotation 702. As shown in FIG. 9, responsive to movement of node ALPINE-3 past the threshold distance, network simulator 102 separates visible annotation 702 into a first visible annotation 910 that retains only unmoved nodes ALPINE-0-ALPINE-2, and a second visible annotation 912 spaced-apart from the first visible annotation and that includes only moved node ALPINE-3. First visible annotations 910 and second visible annotation 912 retain the same fill characteristic. In another example, a second node may be moved from first visible annotation 910 toward second visible annotation 912. In that case, the second node may join the second visible annotation when the second node is within the distance threshold of the second visible annotation. Alternatively, a third visible annotation may be created when the second node is outside the distance thresholds of both the first and second visible annotations.

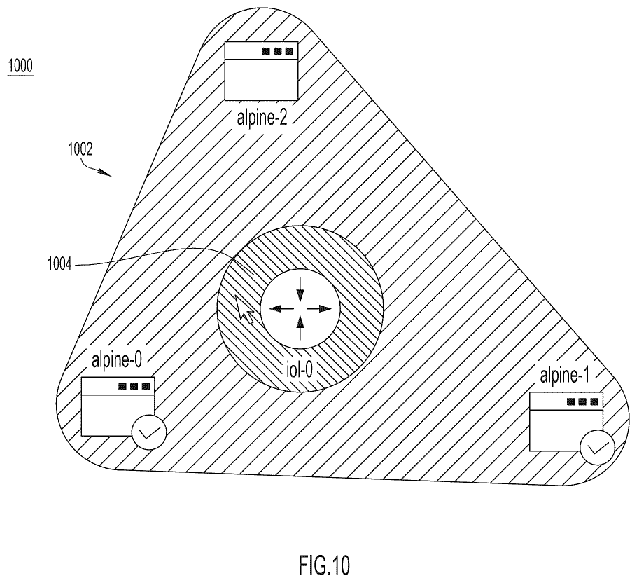

Depending on the tagging pattern of the nodes in a topology, it is possible that a visible annotation encompassing commonly tagged nodes (i.e., nodes tagged with a common tag) may also surround a node that is not tagged with the common tag. For example, the node may be untagged or may be tagged with a tag that differs from the common tag. When network simulator 102 detects that the area of the visible annotation surrounds a node that does not share the common tag, network simulator 102 generates for display a limited-radius visible exclusion zone (also referred to as a “negative space”) around the untagged node and from which the fill characteristic of the visible annotation for the common tag is omitted, which differentiates the node from the commonly tagged nodes and the visible annotation, as is shown by way of example in FIG. 10.

FIG. 10 shows an example GUI 1000 that presents a visible annotation 1002 that encompasses nodes ALPINE-0-ALPINE-2 that share a common tag, and a node IOL-0 that does not share the common tag. In this case, network simulator 102 creates and presents an exclusion zone 1004 around node IOL-0. When node IOL-0 is assigned a tag that is not the common tag, exclusion zone 1004 may include a fill characteristic matched to the tag to differentiate the node/tag from the common tag. More generally, the exclusion zone may be shown visibly as a break in color or pattern from that of the overlapping visible annotation.

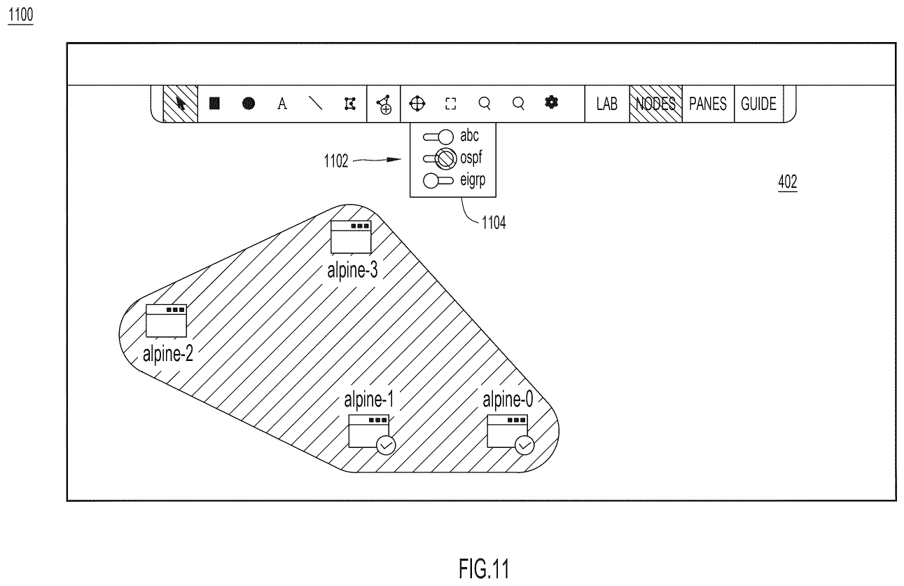

FIG. 11 shows an example GUI 1100 that presents user selectable ON-OFF tag controls. Specifically, GUI 1100 includes a drop-down menu 1102 that presents existing tags (which may or may not be assigned to nodes) ABC, OSPF, and EIGRP adjacent to corresponding ones of sliding selectors 1104. The user may drag each selector to the right or to the left to turn ON the tag or turn OFF the corresponding tag, respectively. Each selector may have initial default position, e.g., ON or OFF. Responsive to the user action, network simulator 102 turns ON or turns OFF the corresponding tag to reflect the user action. This approach may be used to edit other per-tag properties, such as fill characteristic, and the like.

As mentioned above, network simulator 102 may perform dynamic tagging of nodes, now described in connection with FIG. 12. FIG. 12 is a flowchart of example operations 1200 used to perform dynamic tagging of nodes.

At 1202, the user enters into GUI 116 user configurable search criteria (or an API provides the search criteria as an input) defining one or more node properties of interest (or other network properties of interest) to which tags are to be assigned dynamically. As used herein, a node property may also include a network traffic property (e.g., OSPF traffic). The user (or API) may also specify that all node properties are of interest. For example, search criteria may include “tag OSPF,” “tag all network protocols,” and so on. In this way, the user makes selections of (or the API provides an input that defines) node properties of interest, which are received by controller 110. The next operations may be performed without user intervention.

Responsive to the selections/API input, at 1204, controller 110 discovers which of the node properties of interest are allocated to which of the nodes. For example, controller 110 scans/searches the node configurations of the nodes for the one or more node properties of interest. Controller 110 may also scan virtual network 103 during a network simulation. In this case, controller 110 scans the nodes and the network traffic traversing the nodes using node property match filters to discover which of the nodes are using/implementing which of the one or more node properties of interest. Based on the discovery, controller 110 compiles mappings of which of the one or more node properties of interest are allocated to which of the nodes.

At 1206, controller 110 creates distinct tags as “dynamic” tags for corresponding ones of the one or more node properties of interest that are found during the discovery. At 1208, controller 110 assigns to the nodes the dynamic tags in accordance with the mappings such that the dynamic tags match how the one or more node properties are allocated to the nodes. A given node may receive multiple dynamic tags. This produces tagged nodes.

At 1210, controller 110 generates for display visible annotations corresponding to the tagged nodes in the manner described above.

Dynamic tagging can be used to update tags automatically without manual intervention as a network topology changes over time. For example, automatic tagging may be used to update a visible annotation to reflect when a node (e.g., node Cv-4 introduced above) moves (e.g., out of Area 0). In an embodiment, a special form of a dynamic tag (e.g., in the form “annotate:dynamic:ospf”) may be applied to nodes. When this tag is applied, the underlying network fabric (e.g., controller 110 monitoring the virtual network) listens for OSPF traffic and creates dynamic tags on the fly when it learns a node is “speaking” OSPF in a specific area. The dynamic tag is added in the form, e.g., “_annotate:ospf area 0.” The leading ‘_’ signifies they the dynamic tag is machine-created. The dynamic tagging is performed to maintain filtering and searching support in the virtual network. As described above, the dynamic tags can then be turned on or off manually (or made static).

The level to which dynamic tags depends on information learned from scanning the network topology. Examples of dynamic tags include “annotate:dynamic:routing,” “annotate:dynamic:vtp,” and “annotate:dynamic:ipv6.” In addition, a special “protoX:NAME” tag is available, whereby a protocol number X is used to filter on network traffic originating from a node. The “:NAME” argument then provides a mechanism to label the visible annotation.

For dynamic tagging, learning of network protocols may be performed at the fabric (i.e., virtual network) level using a packet filter. The fabric monitors all network traffic to and from the nodes, and packet sniffers may be used to match on the network traffic based on the specified dynamic tags. To facilitate a fully dynamic set of annotations, annotate:dynamic:all may be used to create all traffic-based annotations.

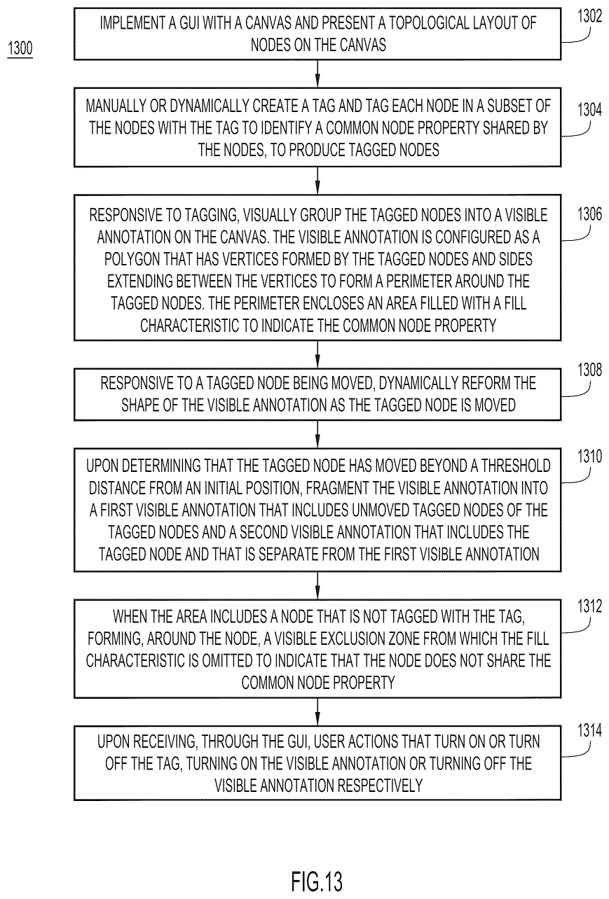

FIG. 13 is a flowchart of an example method 1300 of dynamically and selectively visualizing nodes of a network based on tagging the nodes with tags that identify node properties of the nodes and properties of the network. Method 1300 may be a computer-implemented method performed primarily by a network simulator (e.g., a computer device) including a processor, a memory, and a display and that has access to a database of node and network configurations.

At 1302, a GUI is implemented by the network simulator, and a layout of nodes is presented on a display canvas of the GUI.

At 1304, a tag that identifies a node property (or other network property) is manually created, created by an API, or automatically created, and each node in a subset of the nodes is tagged with the tag to produce tagged nodes. That is, the tag is created responsive to the aforementioned input, and each node is tagged accordingly. The node property is commonly shared among the tagged nodes, which are considered commonly tagged nodes, and the tag is shared in common by the nodes in the subset.

At 1306, responsive to tagging, the tagged nodes are visually grouped into a visible annotation on the display canvas. The visible annotation is configured as a polygon that has vertices formed by the tagged nodes and sides extending between the vertices to form a perimeter around the tagged nodes. The perimeter encloses an area filled with a fill characteristic to indicate the common node property. The perimeter may be stretched tightly around the tagged nodes to minimize the area.

At 1308, responsive to a tagged node of the tagged nodes being moved, a shape of the visible annotation is dynamically reformed (e.g., stretched or shrunk) as/while the tagged node is moved. That is, the shape of the visual annotation closely follows the movement of the tagged node in real-time as the tagged node moves.

At 1310, upon a determination being made that the tagged node has moved away from the visible annotation as initially configured and beyond a threshold distance from an initial position of the tagged node before it was moved, the visible annotation is fragmented into a first visible annotation that includes unmoved tagged nodes of the tagged nodes and a second visible annotation that includes the tagged node and that is separate from the first visible annotation. In another example, when a tag is removed from a node, the visible annotation for the tag is redrawn without the node.

At 1312, when a determination is made that the area of the polygon includes a node that is not tagged with the tag, a visible exclusion zone from which the fill characteristic is omitted is formed around the node, which indicates that the node does not share the common node property.

At 1314, when a user action that turns ON or turns OFF the tag is received through the GUI, the visible annotation is turned on or turned OFF, respectively

Operations 1304-1314 may be repeated with different tags to distinctly visualize multiple visible annotations (e.g., first, second, and third annotations) for multiple tags (e.g., first, second, and third tags) that identify multiple node/network properties (e.g., first, second, and third node/network properties).

In summary, embodiments presented herein employ “smart annotations” to simplify using visible annotations by automatically drawing visible annotations around nodes current locations of the nodes on a display canvas based on tags assigned manually or automatically to the nodes. The visible annotations can be visually hidden/shown and the tags can be dynamically generated based on a node configuration or state. Additionally, visible annotations follow the movement of the nodes, eliminating user actions to modify the annotation shape when node positions are updated, for example.

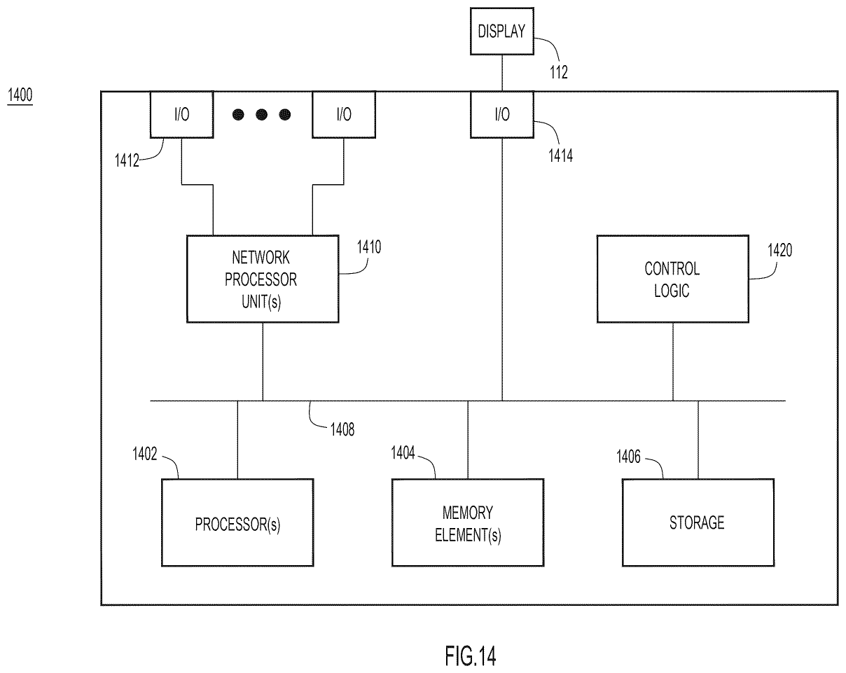

Referring to FIG. 14, FIG. 14 illustrates a hardware block diagram of a computing device 1400 that may perform functions associated with operations discussed herein in connection with the techniques depicted in FIGS. 1-13. In various embodiments, a computing device or apparatus, such as computing device 1400 or any combination of computing devices 1400, may be configured as any entity/entities as discussed for the techniques depicted in connection with FIGS. 1-13 in order to perform operations of the various techniques discussed herein. For example, computing device may represent network simulator 102 and nodes 104, for example.

In at least one embodiment, the computing device 1400 may be any apparatus that may include one or more processor(s) 1402, one or more memory element(s) 1404, storage 1406, a bus 1408, one or more network processor unit(s) 1410 interconnected with one or more network input/output (I/O) interface(s) 1412, one or more I/O interface(s) 1414, and control logic 1420. In various embodiments, instructions associated with logic for computing device 1400 can overlap in any manner and are not limited to the specific allocation of instructions and/or operations described herein.

In at least one embodiment, processor(s) 1402 is/are at least one hardware processor configured to execute various tasks, operations and/or functions for computing device 1400 as described herein according to software and/or instructions configured for computing device 1400. Processor(s) 1402 (e.g., a hardware processor) can execute any type of instructions associated with data to achieve the operations detailed herein. In one example, processor(s) 1402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1404 and/or storage 1406 is/are configured to store data, information, software, and/or instructions associated with computing device 1400, and/or logic configured for memory element(s) 1404 and/or storage 1406. For example, any logic described herein (e.g., control logic 1420) can, in various embodiments, be stored for computing device 1400 using any combination of memory element(s) 1404 and/or storage 1406. Note that in some embodiments, storage 1406 can be consolidated with memory element(s) 1404 (or vice versa), or can overlap/exist in any other suitable manner.

In at least one embodiment, bus 1408 can be configured as an interface that enables one or more elements of computing device 1400 to communicate in order to exchange information and/or data. Bus 1408 can be implemented with any architecture designed for passing control, data and/or information between processors, memory elements/storage, peripheral devices, and/or any other hardware and/or software components that may be configured for computing device 1400. In at least one embodiment, bus 1408 may be implemented as a fast kernel-hosted interconnect, potentially using shared memory between processes (e.g., logic), which can enable efficient communication paths between the processes.

In various embodiments, network processor unit(s) 1410 may enable communication between computing device 1400 and other systems, entities, etc., via network I/O interface(s) 1412 (wired and/or wireless) to facilitate operations discussed for various embodiments described herein. In various embodiments, network processor unit(s) 1410 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1400 and other systems, entities, etc. to facilitate operations for various embodiments described herein. In various embodiments, network I/O interface(s) 1412 can be configured as one or more Ethernet port(s), Fibre Channel ports, any other I/O port(s), and/or antenna(s)/antenna array(s) now known or hereafter developed. Thus, the network processor unit(s) 1410 and/or network I/O interface(s) 1412 may include suitable interfaces for receiving, transmitting, and/or otherwise communicating data and/or information in a network environment.

I/O interface(s) 1414 allow for input and output of data and/or information with other entities that may be connected to computing device 1400. For example, I/O interface(s) 1414 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user (e.g., display 112), such as, for example, a computer monitor, a display screen, or the like.

In various embodiments, control logic 1420 can include instructions that, when executed, cause processor(s) 1402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1404 and/or storage 1406 can store data, software, code, instructions (e.g., processor instructions), logic, parameters, combinations thereof, and/or the like used for operations described herein. This includes memory element(s) 1404 and/or storage 1406 being able to store data, software, code, instructions (e.g., processor instructions), logic, parameters, combinations thereof, or the like that are executed to carry out operations (including generating GUIs for display and interacting with the GUIs) in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, in some aspects, the techniques described herein relate to a method performed by a computer device with a display, including: generating a graphical user interface (GUI) that presents a layout of nodes on a display canvas; tagging each node in a subset of the nodes with a tag that identifies a common node property that the subset of the nodes share in common, to produce tagged nodes; and responsive to tagging, visually grouping the tagged nodes into a visible annotation on the display canvas, wherein the visible annotation is configured as a polygon that has vertices formed by the tagged nodes and sides extending between the vertices to form a perimeter around the tagged nodes, and that encloses an area filled with a fill characteristic to indicate the common node property.

In some aspects, the techniques described herein relate to a method, further including: configuring the perimeter to minimize the area of the polygon.

In some aspects, the techniques described herein relate to a method, further including: responsive to a tagged node of the tagged nodes being moved, dynamically reforming a shape of the visible annotation as the tagged node is moved.

In some aspects, the techniques described herein relate to a method, wherein: reforming the shape of the polygon includes, while the tagged node is being moved, dynamically adjusting lengths of adjoining sides of the sides of the polygon that are incident to the tagged node, and adjusting the area.

In some aspects, the techniques described herein relate to a method, wherein: dynamically adjusting the lengths includes dynamically stretching or shrinking the adjoining sides while the tagged node is being moved.

In some aspects, the techniques described herein relate to a method, further including: upon determining that the tagged node has moved beyond a threshold distance from an initial position of the tagged node, fragmenting the visible annotation on the display canvas into a first visible annotation that includes unmoved tagged nodes of the tagged nodes and a second visible annotation that includes the tagged node and that is separate from the first visible annotation.

In some aspects, the techniques described herein relate to a method, further including: providing an ON-OFF tag control for the tag; upon receiving, through the GUI, a first action that sets the ON-OFF tag control to ON, turning ON the visible annotation; and upon receiving, through the GUI, a second action that sets the ON-OFF tag control to OFF, turning OFF the visible annotation, while the tagged nodes remain tagged.

In some aspects, the techniques described herein relate to a method, further including: receiving manual selections of the subset of the nodes from the GUI, wherein tagging includes tagging responsive to the manual selections.

In some aspects, the techniques described herein relate to a method, further including: storing configuration information that defines node properties of the nodes; automatically searching the configuration information to discover the common node property; and responsive to finding the common node property by searching, performing tagging automatically.

In some aspects, the techniques described herein relate to a method, further including: when the area includes a node among the nodes that is not tagged with the tag, forming, around the node, a visible exclusion zone from which the fill characteristic is omitted to indicate that the node does not share the common node property.

In some aspects, the techniques described herein relate to a method, further including: presenting, on the display canvas, limited clearance zones around respective ones of the tagged nodes such that the sides of the polygon terminate at the limited clearance zones and do not touch the tagged nodes.

In some aspects, the techniques described herein relate to a method, wherein: the nodes represent network nodes and the tag defines a network related property; and the network related property includes one of a network protocol, a network domain, a network device type, and a network region.

In some aspects, the techniques described herein relate to an apparatus including: a network input/output interface to communicate with a network; and a processor coupled to the network input/output interface and configured to perform: generating for display a graphical user interface (GUI) that presents a layout of nodes on a display canvas; tagging each node in a subset of the nodes with a tag that identifies a common node property that the subset of the nodes share in common, to produce tagged nodes; and responsive to tagging, visually grouping the tagged nodes into a visible annotation for presentation on the display canvas, wherein the visible annotation is configured as a polygon having vertices formed by the tagged nodes and sides extending between the vertices to form a perimeter around the tagged nodes, and wherein the perimeter encloses an area filled with a fill characteristic to indicate the common node property.

In some aspects, the techniques described herein relate to an apparatus, wherein the processor is further configured to perform: configuring the perimeter to minimize the area of the polygon.

In some aspects, the techniques described herein relate to an apparatus, wherein the processor is further configured to perform: responsive to a tagged node of the tagged nodes being moved, dynamically reforming a shape of the visible annotation as the tagged node is moved.

In some aspects, the techniques described herein relate to an apparatus, wherein the processor is configured to perform: upon determining that the tagged node has moved beyond a threshold distance from an initial position of the tagged node, fragmenting the visible annotation into a first visible annotation that includes unmoved tagged nodes of the tagged nodes and a second visible annotation that includes the tagged node and that is separate from the first visible annotation.

In some aspects, the techniques described herein relate to an apparatus, wherein the processor is configured to perform: providing an ON-OFF tag control for the tag; upon receiving, through the GUI, a first action that sets the ON-OFF tag control to ON, turning ON the visible annotation; and upon receiving, through the GUI, a second action that sets the ON-OFF tag control to OFF, turning OFF the visible annotation, while the tagged nodes remain tagged.

In some aspects, the techniques described herein relate to a computer-implemented method including: storing configurations that define node properties of nodes; displaying the nodes on a display canvas a graphical user interface (GUI); discovering the node properties and which of the node properties are allocated to which of the nodes; creating tags that define respective ones of the node properties found by discovering; tagging the nodes with the tags to match how the node properties are allocated to the nodes, to produce tagged nodes; and responsive to tagging, visually grouping the tagged nodes into visible annotations based on the tags such that each visible annotation encompasses commonly tagged nodes of the tagged nodes that share a common tag that define a common node property.

In some aspects, the techniques described herein relate to a computer-implemented method, further including: presenting each visible annotation as a polygon having vertices formed by the commonly tagged nodes and sides extending between the vertices to form a perimeter around the commonly tagged nodes, wherein the perimeter encloses an area filled with a distinct fill characteristic to indicate the common node property.

In some aspects, the techniques described herein relate to a computer-implemented method, further including: performing discovering, creating, and visually grouping automatically without manual intervention.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a computer device with a display, comprising:
generating a graphical user interface (GUI) that presents a layout of nodes on a display canvas;
tagging each node in a subset of the nodes with a tag that identifies a common node property that the subset of the nodes share in common, to produce tagged nodes; and
responsive to tagging, visually grouping the tagged nodes into a visible annotation on the display canvas, wherein the visible annotation is configured as a polygon that has vertices formed by the tagged nodes and sides extending between the vertices to form a perimeter around the tagged nodes, and that encloses an area filled with a fill characteristic to indicate the common node property.

2. The method of claim 1, further comprising:
configuring the perimeter to minimize the area of the polygon.

3. The method of claim 1, further comprising:
responsive to a tagged node of the tagged nodes being moved, dynamically reforming a shape of the visible annotation as the tagged node is moved.

4. The method of claim 3, wherein:
reforming the shape of the polygon includes, while the tagged node is being moved, dynamically adjusting lengths of adjoining sides of the sides of the polygon that are incident to the tagged node, and adjusting the area.

5. The method of claim 4, wherein:
dynamically adjusting the lengths includes dynamically stretching or shrinking the adjoining sides while the tagged node is being moved.

6. The method of claim 3, further comprising:
upon determining that the tagged node has moved beyond a threshold distance from an initial position of the tagged node, fragmenting the visible annotation on the display canvas into a first visible annotation that includes unmoved tagged nodes of the tagged nodes and a second visible annotation that includes the tagged node and that is separate from the first visible annotation.

7. The method of claim 1, further comprising:
providing an ON-OFF tag control for the tag;
upon receiving, through the GUI, a first action that sets the ON-OFF tag control to ON, turning ON the visible annotation; and
upon receiving, through the GUI, a second action that sets the ON-OFF tag control to OFF, turning OFF the visible annotation, while the tagged nodes remain tagged.

8. The method of claim 1, further comprising:
receiving inputs that define the subset of the nodes,
wherein tagging includes tagging responsive to the inputs.

9. The method of claim 1, further comprising:
storing configuration information that defines node properties of the nodes;
automatically searching the configuration information to discover the common node property; and
responsive to finding the common node property by searching, performing tagging automatically.

10. The method of claim 1, further comprising:
when the area includes a node among the nodes that is not tagged with the tag, forming, around the node, a visible exclusion zone from which the fill characteristic is omitted to indicate that the node does not share the common node property.

11. The method of claim 1, further comprising:
presenting, on the display canvas, limited clearance zones around respective ones of the tagged nodes such that the sides of the polygon terminate at the limited clearance zones and do not touch the tagged nodes.

12. The method of claim 1, wherein:
the nodes represent network nodes and the tag defines a network related property; and
the network related property includes one of a network protocol, a network domain, a network device type, and a network region.

13. An apparatus comprising:
a network input/output interface to communicate with a network; and
a processor coupled to the network input/output interface and configured to perform:
generating for display a graphical user interface (GUI) that presents a layout of nodes on a display canvas;
tagging each node in a subset of the nodes with a tag that identifies a common node property that the subset of the nodes share in common, to produce tagged nodes; and
responsive to tagging, visually grouping the tagged nodes into a visible annotation for presentation on the display canvas, wherein the visible annotation is configured as a polygon having vertices formed by the tagged nodes and sides extending between the vertices to form a perimeter around the tagged nodes, and wherein the perimeter encloses an area filled with a fill characteristic to indicate the common node property.

14. The apparatus of claim 13, wherein the processor is further configured to perform:
configuring the perimeter to minimize the area of the polygon.

15. The apparatus of claim 13, wherein the processor is further configured to perform:
responsive to a tagged node of the tagged nodes being moved, dynamically reforming a shape of the visible annotation as the tagged node is moved.

16. The apparatus of claim 15, wherein the processor is configured to perform:
upon determining that the tagged node has moved beyond a threshold distance from an initial position of the tagged node, fragmenting the visible annotation into a first visible annotation that includes unmoved tagged nodes of the tagged nodes and a second visible annotation that includes the tagged node and that is separate from the first visible annotation.

17. The apparatus of claim 13, wherein the processor is configured to perform:
providing an ON-OFF tag control for the tag;
upon receiving, through the GUI, a first action that sets the ON-OFF tag control to ON, turning ON the visible annotation; and
upon receiving, through the GUI, a second action that sets the ON-OFF tag control to OFF, turning OFF the visible annotation, while the tagged nodes remain tagged.

18. A computer-implemented method comprising:
storing configurations that define node properties of nodes;
displaying the nodes on a display canvas a graphical user interface (GUI);
discovering the node properties and which of the node properties are allocated to which of the nodes;
creating tags that define respective ones of the node properties found by discovering;
tagging the nodes with the tags to match how the node properties are allocated to the nodes, to produce tagged nodes; and
responsive to tagging, visually grouping the tagged nodes into visible annotations based on the tags such that each visible annotation encompasses commonly tagged nodes of the tagged nodes that share a common tag that define a common node property.

19. The computer-implemented method of claim 18, further comprising:
presenting each visible annotation as a polygon having vertices formed by the commonly tagged nodes and sides extending between the vertices to form a perimeter around the commonly tagged nodes, wherein the perimeter encloses an area filled with a distinct fill characteristic to indicate the common node property.

20. The computer-implemented method of claim 18, further comprising:
performing discovering, creating, and visually grouping automatically without manual intervention.
